(19) United States
(12) Patent Application Publication
(10) Pub. No.: US 2020/0114320 A1
(43) Pub. Date: Apr. 16, 2020

(54) Bubble Splitter

(71) Applicant: Chester SOHN, Gig Harbor, CA (US)

(72) Inventor: Chester SOHN, Gig Harbor, CA (US)

(21) Appl. No.: 16/157,048

(22) Filed: Oct. 10, 2018

(51) Int. Cl. B01F 5/06; B01F 3/04; C02F 1/72; C02F 1/68

(52) U.S. Cl. CPC B01F 5/0604; B01F 3/04106; B01F 3/04503; B01F 2215/0052; C02F 1/68; B01F 2003/04879; B01F 2003/04921; C02F 1/727

(57) ABSTRACT

A bubble splitter, which is arranged for splitting gas bubbles in a bubbled liquid in at least a micro size, includes a splitting housing, a plurality of first splitting discs, and a plurality of second splitting discs. The first and second splitting discs are alternating with each other to be spacedly supported within the splitting housing, wherein a plurality of peripheral passages are formed at peripheral portions of the first splitting discs respectively and a plurality of central passages are formed at center portions of the second splitting discs respectively. The bubbled liquid is detoured to radially and outwardly move from the central passage to the peripheral passage and is detoured to radially and inwardly move from the peripheral passage to the central passage so as to split the gas bubbles in the bubbled liquid in at least a micro size.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a bubble generator, and more particularly to a device and process for generating and splitting bubbles in a liquid.

### Description of Related Arts

In recent years, micro-bubbles and nano-bubbles technologies have been drawn great attention since micro-bubbles and nano-bubbles can be used in a variety of applications such as water treatment, biomedical engineering, and nano-materials. Accordingly, such air bubbles are very small that the air bubbles will act as oxidizing agents to treat contaminated water or waste water. In other words, such micro-bubbles and nano-bubbles are great products for water disinfection, degradation of organic compounds and defouling. Since no chemical is added into the micro-bubbles and nano-bubbles, micro-bubbles and nano-bubbles are environmentally friendly product for water treatment, odor removal, and defouling.

### SUMMARY OF THE PRESENT INVENTION

The invention is advantageous in that it provides a bubble generation system and method thereof for generating gas bubbles in liquid and for splitting the gas bubbles in liquid in at least a micro size.

Another advantage of the invention is to provide a bubble generation system, which comprises a bubble splitter for detouring the bubble liquid within a splitting compartment of the splitting housing in a radially in-and-out direction so as to split the gas bubbles in micro size or even in nano size.

Another advantage of the invention is to provide a bubble generation system, which can produce different types of micro-bubbles or nano-bubbles in liquid, wherein the gas bubbles can be air bubbles, oxygen bubbles, nitrogen bubbles, and/or hydrogen bubbles, and the liquid can water or diesel fuel.

Another advantage of the invention is to provide a bubble splitter, which can be used in a variety of applications by simply coupling the bubble splitter to a liquid outlet, such as connecting the bubble splitter to a water faucet or shower head for water treatment, or connecting the bubble splitter to a washer inlet for defouling.

Another advantage of the invention is to provide a bubble splitter, which does not require any chemical compound being added into the gas bubbles or liquid, such that the bubble splitter is an environmentally friendly product for generating micro-bubbles or nano-bubbles in liquid for water treatment, odor removal, defouling, and the like.

Another advantage of the invention is to a bubble splitter, wherein no expensive or complicated structure is required to employ in the present invention in order to achieve the above mentioned objects. Therefore, the present invention successfully provides an economic and efficient solution for providing an effective tool to generate micro-bubbles or nano-bubbles in liquid.

Additional advantages and features of the invention will become apparent from the description which follows, and may be realized by means of the instrumentalities and combinations particular point out in the appended claims.

According to the present invention, the foregoing and other objects and advantages are attained by a bubble generation system, which comprises a bubble generator adapted for generating gas bubbles in liquid to form a bubbled liquid, and a bubble splitter communicatively connected to the bubble generator for splitting the gas bubbles in the bubbled liquid in at least a micro size. The bubble splitter comprises:

a tubular splitting housing having an outlet, an inlet connected to the bubble generator, and a splitting compartment defined between the outlet and the inlet; and

a bubble splitting configuration provided in the splitting compartment, which comprises:

a plurality of peripheral passages defined at a peripheral portion of the splitting housing; and

a plurality of central passages defined at a center portion of the splitting housing, wherein the peripheral passages are alternating with the central passages within the splitting compartment for detouring the bubbled liquid from the inlet to the outlet in such a manner that the bubbled liquid is detoured to radially and outwardly move from the central passage to the peripheral passage and is detoured to radially and inwardly move from the peripheral passage to the central passage so as to split the gas bubbles in the bubbled liquid in at least a micro size.

In accordance with another aspect of the invention, the present invention comprises a method of generating gas bubbles, each having at least a micro size, in liquid, comprising the following steps.

(A) Initially generate gas bubbles in liquid via a bubble generator to form a bubble liquid.

(B) Guide the bubble liquid into an inlet of a splitting housing of a bubble splitter.

(C) Detour the bubble liquid within a splitting compartment of the splitting housing in a radially in-and-out direction via a plurality of peripheral passages and a plurality of central passages alternating with the central passages within the splitting compartment that:

the bubbled liquid is detoured to radially and outwardly move from the central passage to the peripheral passage, and

the bubbled liquid is detoured to radially and inwardly move from the peripheral passage to the central passage so as to split the gas bubbles in the bubbled liquid in at least a micro size.

(D) Release the gas bubbles with at least a micro size in liquid out of an outlet of the splitting housing.

In accordance with another aspect of the invention, the present invention comprises a bubble splitter for splitting gas bubbles in a bubbled liquid in at least a micro size, comprising:

a tubular splitting housing having an outlet, an inlet connected to the bubble generator, and a splitting compartment defined between the outlet and the inlet;

a plurality of first splitting discs spacedly supported within the splitting compartment, wherein a plurality of peripheral passages are formed at peripheral portions of the first splitting discs respectively; and

a plurality of second splitting discs spacedly supported within the splitting compartment and alternating with the first splitting discs, wherein a plurality of central passages are formed at center portions of the second splitting discs respectively, wherein the splitting housing is arranged for detouring the bubbled liquid from the inlet to the outlet in such a manner that the bubbled liquid is detoured to radially and outwardly move from the central passage to the peripheral passage and is detoured to radially and inwardly move from the peripheral passage to the central passage so as to split the gas bubbles in the bubbled liquid in at least a micro size.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a bubble generation system according to a preferred embodiment of the present invention.

FIG. 2 is an exploded perspective view of the bubble splitter according to the preferred embodiment of the present invention.

FIG. 3 is a sectional view of the bubble splitter according to the preferred embodiment of the present invention.

FIG. 4 is an exploded perspective view of a first alternative mode of a bubble splitter according to the preferred embodiment of the present invention.

FIG. 5 illustrates the first and second splitting discs of the first alternative mode of the bubble splitter according to the preferred embodiment of the present invention.

FIG. 6 illustrates a liquid flow direction of the first alternative mode of the bubble splitter according to the preferred embodiment of the present invention.

FIG. 7 illustrates a second alternative mode of the bubble splitter according to the preferred embodiment of the present invention.

FIG. 8 illustrates a liquid flow direction of the second alternative mode of the bubble splitter according to the preferred embodiment of the present invention.

FIG. 9 is a flow diagram illustrating a method of generating micro or nano gas bubbles in liquid according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

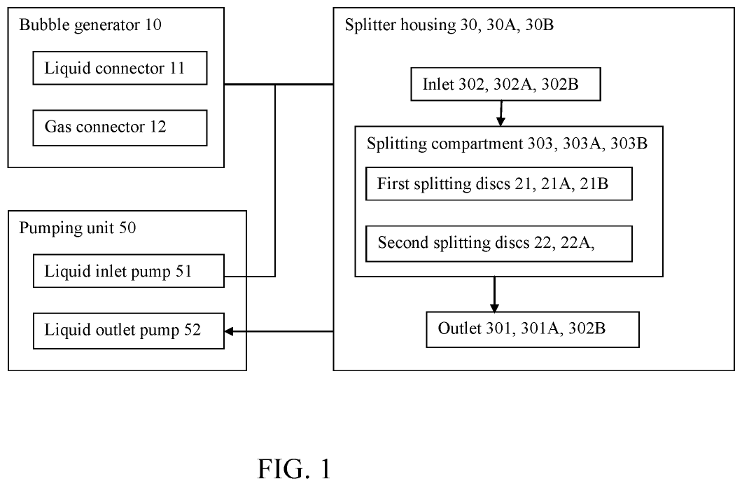

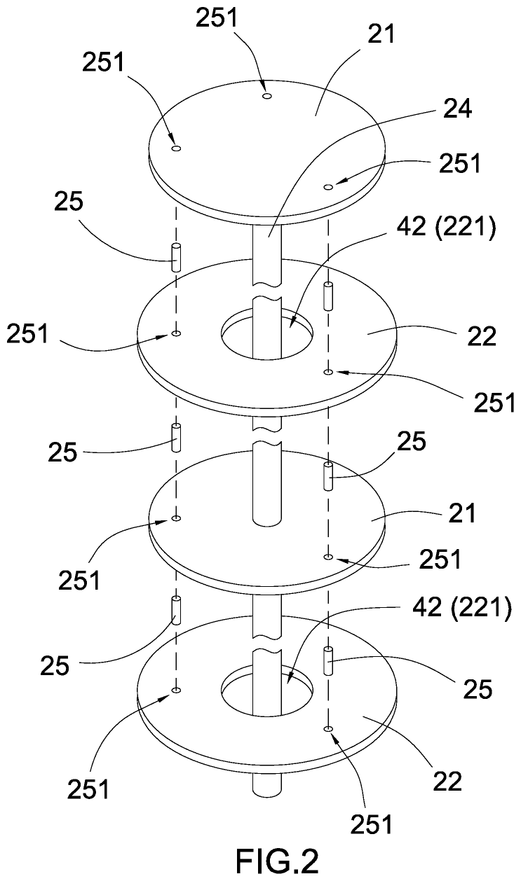

Referring to FIGS. 1 to 3 of the drawings, a bubble generation system according to a preferred embodiment of the present invention is illustrated, wherein the bubble generation system comprises a bubble generator 10 and a bubble splitter 20.

The bubble generator 10 is arranged for initially generating gas bubbles in liquid to form a bubbled liquid. The sizes of the gas bubbles may be larger than micro size being produced by the bubble generator 10. According to the preferred embodiment, the bubble generator 10 comprises a liquid connector 11 adapted for connecting to a liquid source, and a gas connector 12 adapted for connecting to a gas source.

The bubble splitter 20 is communicatively connected to the bubble generator 10 for splitting the gas bubbles in the bubbled liquid that the gas bubbles are split in at least micro size or even nano size. The bubble splitter 20 comprises a tubular splitter housing 30 and a bubble splitting configuration 40.

The splitter housing 30 has an outlet 301, an inlet 302 connected to the bubble generator 10, and a splitting compartment 303 defined between the outlet 301 and the inlet 302. Accordingly, the splitting housing 30 has a cylindrical shape to define a first wall 31, a second wall 32 and a surrounding wall 33 extended between the first and second walls 31, 32 to define the splitting compartment 303 within the surrounding wall 33. The outlet 301 is formed at the second wall 32 and is configured with an elongated threaded tubular adapter. The inlet 302 is formed at the first wall 31 and is also is configured with an elongated threaded tubular adapter. Preferably, the outlet 301 is coaxially aligned with the inlet 302, wherein the bubbled liquid is guided to radially flow in the splitter housing 30.

The bubble splitting configuration 40 is provided in the splitting compartment 303 to detour the gas bubbles in liquid from the inlet 302 to the outlet 301 through the splitting compartment 303 so as to complete the bubble splitting process. The bubble splitting configuration 40 comprises a plurality of peripheral passages 41 defined at a peripheral portion of the splitting housing 30 and a plurality of central passages 42 defined at a center portion of the splitting housing 30.

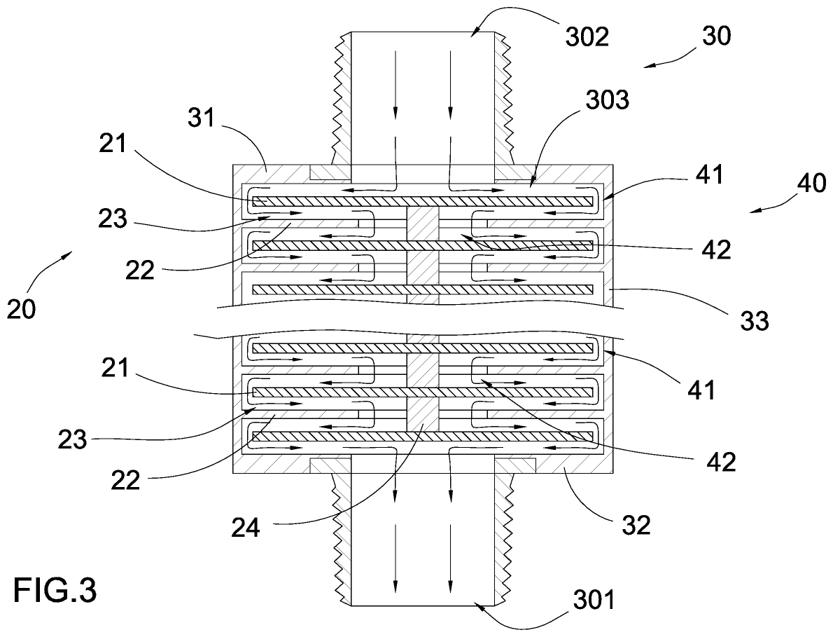

As shown in FIG. 3, the peripheral passages 41 are alternating with the central passages 42 within the splitting compartment 303 for detouring the bubbled liquid from the inlet 302 to the outlet 301. In particular, the bubbled liquid is detoured within the splitting compartment 303 in a radially in-and-out direction. The bubbled liquid is detoured to radially and outwardly move from the central passage 42 to the peripheral passage 41 and is detoured to radially and inwardly move from the peripheral passage 41 to the central passage 42 so as to split the gas bubbles in the bubbled liquid in at least a micro size or even a nano size.

According to the preferred embodiment, in order to form the peripheral passages 41 and the central passages 42 within the splitting compartment 303, the bubble splitter 20 comprises a plurality of first splitting discs 21 and a plurality of second splitting discs 22 alternating with the first splitting discs 21. Accordingly, the first and second splitting discs 21, 22 are spacedly supported within the splitting compartment 303, wherein a plurality of splitting channels 23 are formed between the first and second splitting discs 21, 22. In other words, each of the splitting channels 23 is defined at a clearance between the first and second splitting discs 21, 22. Preferably, the first and second splitting discs 21, 22 are parallel with each other, such that the widths of the splitting channels 23 are even and are identical to each other.

As shown in FIG. 3, the peripheral passages 41 are formed at peripheral portions of the first splitting discs 21 respectively and the central passages 42 are formed at center portions of the second splitting discs 22 respectively. The splitting channels 23 are communicated between the peripheral passages 41 and the central passages 42. In other words, the bubbled liquid is guided to flow from one of the central passages 42 to the peripheral passage 41 through the corresponding splitting channel 33. Likewise, the bubbled liquid is guided to flow from the peripheral passage 41 to the next central passage 42 through the following splitting channel 23.

The flow direction of the bubble splitter 20 is that the bubbled liquid is guided to flow into the splitting compartment 303 through the inlet 302 and is then continuously passed through the peripheral passages 41, the central passages 42, and the splitting channel 23 in a sequent manner to split the gas bubbles in the bubbled liquid. Then, the bubbled liquid is discharged at the outlet 301 of the bubble splitter 20.

Preferably, the bubbled liquid is guided to flow from the inlet 302 into the first splitting channel 23. Then, the bubbled liquid is blocked by the first splitting disc 21 and is detoured to flow radially and outwardly at the first splitting channel 23 to the first peripheral passage 41. The bubbled liquid is blocked by the second splitting disc 21 and is detoured to flow to the next (second) splitting channel 23 by turning at its 180° at the first peripheral passage 41. In other words, the bubbled liquid is detoured to flow radially and inwardly at the second splitting channel 23 to the first central passage 42. Likewise, the bubbled liquid is blocked by the next first splitting disc 21 and is detoured to flow radially and outwardly at the third splitting channel 23 to the first peripheral passage 41 by turning at its 180° at the first central passage 42. Therefore, the gas bubbles are split in half by turning 180° at the peripheral passages 41 and turning 180° at the central passages 42 in sequence.

According to the preferred embodiment, the splitting housing 30 and the first and second splitting discs 21, 22 are preferably made of noble material, such as platinum, gold, or plastic (ABS), such that the splitting housing 30 and the first and second splitting discs 21, 22 will not chemically react with the gas bubble and/or the liquid. In one embodiment, a diameter of each of the first splitting discs 21 is smaller than a diameter of each of the second splitting discs 22. Preferably, there are totally seventeen first and second splitting discs 21, 22 spacedly and coaxially supported within the splitting housing 30.

The peripheral passages 41 and the central passages 42 can be formed within the splitting housing 20 in different ways. In one embodiment, the diameter of each of the first splitting discs 21 is smaller than the diameter of the splitting housing 30, i.e. a diameter of the surrounding wall 33, such that each of the peripheral passages 41 is formed between a peripheral edge of the first splitting disc 21 and the surrounding wall 33 of the splitting housing 30. In other words, the bubbled liquid will turn 180° at the peripheral edges of the first splitting discs 21 via the peripheral passages 41. Each of the second splitting discs 22 has a central through slot 221 formed at a center thereof to define the central passage 42 thereat. Therefore, the bubbled liquid will pass through the center shaft slot 221 and is turn 180° thereat via the central passages 42.

The bubble splitter 20 further comprises a disc supporting structure for spacedly supporting the first and second splitting discs 21, 22 in the splitting housing 30. In one embodiment of the disc supporting structure, the bubble splitter 20 comprises a supporting shaft 24 coaxially extended at central portions of the first splitting discs 21 to spacedly support the first splitting discs 21 within the splitting compartment 303. Accordingly, the supporting shaft 24 has a plurality of shaft sections extended from the central portions of the first splitting discs 21 and are coupled with each other. Preferably, the supporting shaft 24 is coaxially supported within the splitting compartment 303 to align with the outlet 31 and the inlet 32.

It is worth mentioning that the supporting shaft 24 is extended through the central through slots 221 of the second splitting discs 22 in order to couple the first splitting discs 21 which are alternating with the second splitting discs 22. Furthermore, the diameter of the supporting shaft 24 is smaller than the diameter of the central through slot 221. Therefore, the central passage 42 is formed at a clearance between a circumferential edge of the central through slot 221 and the supporting shaft 24.

The peripheral edges of the second splitting discs 22 are integrally extended to the surrounding wall 33 of the splitting housing 30 so as to spacedly support the second splitting discs 22 within the splitting compartment 303. In other words, the diameter of the splitting housing 30, i.e. the diameter of the surrounding wall 33, is the same as the diameter of each of the second splitting discs 22.

The disc supporting structure of the bubble splitter 20 further comprises a plurality of disc spacers 25 coupled between the first and second splitting discs 21, 22 to retain a distance between the first and second splitting discs 21, 22. Preferably, at least three of the disc spacers 25 are retained between the first and second splitting discs 21, 22. Accordingly, a plurality of retention slots 251 are spacedly formed at each of the first and second splitting discs 21, 22, wherein one end of the disc spacer 25 is engaged with one of the retention slots 251 at the first splitting disc 21 and the opposed end of the disc spacer 25 is engaged with the aligned retention slot 251 at the second splitting disc 22 to retain the distance between first and second splitting discs 21, 22. In other words, a height of the disc spacer 25 is the same as the distance between the first and second splitting discs 21, 22.

According to the preferred embodiment, the bubble generation system further comprises a pumping unit 50 for pressurizing the bubbled liquid within the splitting compartment 303 to ensure the bubbled liquid being pressurized to flow from the inlet 302 to the outlet 301 of the splitting housing 30.

The pumping unit 50 comprises a liquid inlet pump 51 operatively connecting to the bubble generator 10 for regulating the flow of the liquid thereto. It is worth mentioning the liquid inlet pump 51 can be incorporated to pump the liquid into the inlet 302 of the splitting housing 30 before the gas bubbles are formed in the liquid or after the gas bubbles are formed in the liquid as the bubbled liquid. The pumping unit 50 further comprises a liquid outlet pump 52 operatively connecting to the bubble splitter 20 for pumping the gas bubbles with at least a micro size in liquid out of the outlet 301 of the splitting housing 30. Accordingly, the power of the liquid inlet pump 51 can be greater, equal, or smaller than the power of the liquid outlet pump 52.

According to the preferred embodiment, the different kinds of gases can be formed in different kinds of liquids. In one embodiment, the liquid can be purified water, drinking water, tape water, gaseous fuel, diesel fuel or any kind of fluid. The gas can be air, oxygen gas, ozone gas, hydrogen gas, carbon dioxide gas, and/or nitrogen gas that the gas connector 12 can be the corresponding air connector, oxygen gas connector, ozone gas connector, hydrogen gas connector, and/or nitrogen gas connector to generate air bubbles, oxygen bubbles, ozone bubbles, hydrogen bubbles, nitrogen bubbles in the liquid. For example, oxygen gas can be generated in the drinking water to form the oxygen bubbled liquid, such that when the oxygen bubbled liquid passes through the bubble splitter 20, thousands of oxygen bubbles, at least 62 thousands of bubbles, each having a nano size, will be formed in the drinking water as the oxygen rich drinking water (oxygenated water). Likewise, the oxygen gas can be generated in the orange juice, apple juice, or the like. In one embodiment, ozone gas can be generated in the water and split by the bubble splitter 20 in either micro size or nano size to form the ozone bubbled water (ozonated water) for laundry, such that no detergent or other chemicals is needed. Thus, ozone bubbled water is also odor removing agent. Nitrogen bubbles in liquid are essential for plant growth and nourishment. When nano oxygen bubbles are formed in the diesel fuel, the oxygen rich diesel fuel, such as 2-5% of oxygen, will enhance the engine internal combustion process. For example, the diesel fuel is pumped to the bubble splitter 20 to mix and split with the oxygen bubbles before pumping to the engine. It is worth mentioning that the gas bubbles, in micro size or nano size, can be retained in the liquid at least 60-90 days. Thus, two or more different gas bubbles can be formed in the liquid. For example, oxygen gas and hydrogen gas can be generated in the water at the same time, such that nano oxygen bubbles and nano hydrogen bubbles are formed in water after passing through the bubble splitter 20. In other words, mixture of different gas bubbles can be formed in the liquid.

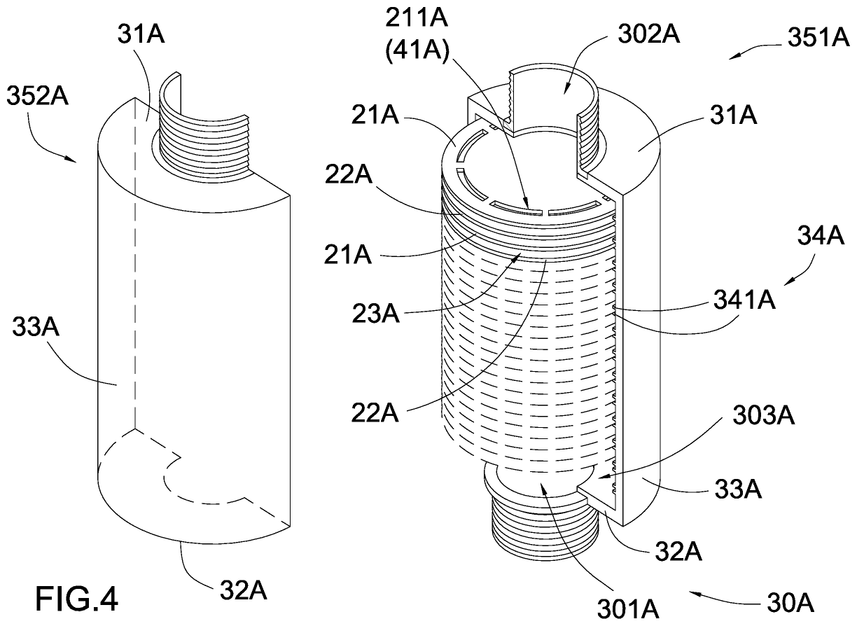

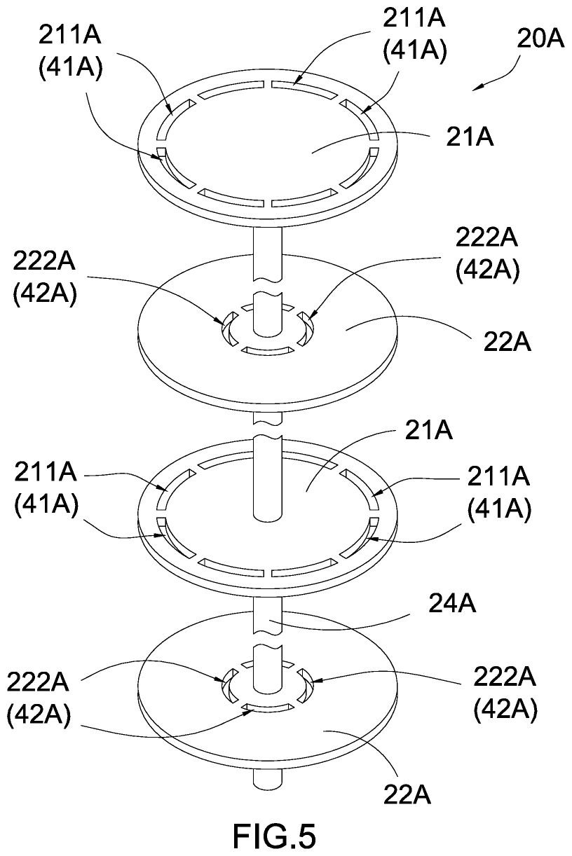

FIGS. 4 to 6 illustrates a first alternative mode of the bubble splitter 20A. Accordingly, the splitter housing 30A has an outlet 301A, an inlet 302A connected to the bubble generator 10, and a splitting compartment 303A defined between the outlet 301A and the inlet 302A. Accordingly, the splitting housing 30A has a cylindrical shape to define a first wall 31A, a second wall 32A and a surrounding wall 33A extended between the first and second walls 31A, 32A to define the splitting compartment 303A within the surrounding wall 33A. The outlet 301A is formed at the second wall 32A and the inlet 302A is formed at the first wall 31A.

The first splitting discs 21A are alternating with the second splitting discs 22A within the splitting compartment 303A of the splitting housing 30A, and the first and second splitting discs 21A, 22A are spacedly supported within the splitting compartment 303A. A plurality of splitting channels 23A are formed between the first and second splitting discs 21A, 22A. Accordingly, the diameter of the first splitting disc 21A is the same as the diameter of the second splitting disc 22A.

The bubble splitting configuration 40A is provided in the splitting compartment 303A to detour the gas bubbles in liquid from the inlet 302A to the outlet 301A through the splitting compartment 303A so as to complete the bubble splitting process via the peripheral passages 41A and the central passages 42A.

The peripheral passages 41A are formed at peripheral portions of the first splitting discs 21A respectively. In particular, each of the first splitting discs 21A has a plurality of peripheral through slots 211A spacedly and coaxially formed at the peripheral portion of the first splitting disc 21A to form the peripheral passages 41A thereat. Accordingly, each of the peripheral through slots 211A has an arc shape formed at the peripheral portion of the first splitting disc 21A.

The central passages 42A are formed at the center portions of the second splitting discs 22A respectively. In particular, each of the second splitting discs 22A has a plurality of central through slots 222A spacedly and coaxially formed at the center portion of the second splitting disc 22A to form the central passages 42A thereat. Accordingly, each of the second splitting discs 22A has two or more central through slots 222A formed thereat. However, each of the central through slots 222A is not located at the center of the second splitting disc 22A. Each of the central through slots 222A has an arc shape formed at the center portion of the second splitting disc 22A.

Therefore, the gas bubbles are split in half by turning 180° at the peripheral passages 41A via the peripheral through slots 211A and turning 180° at the central passages 42A via the central through slots 222A in sequence.

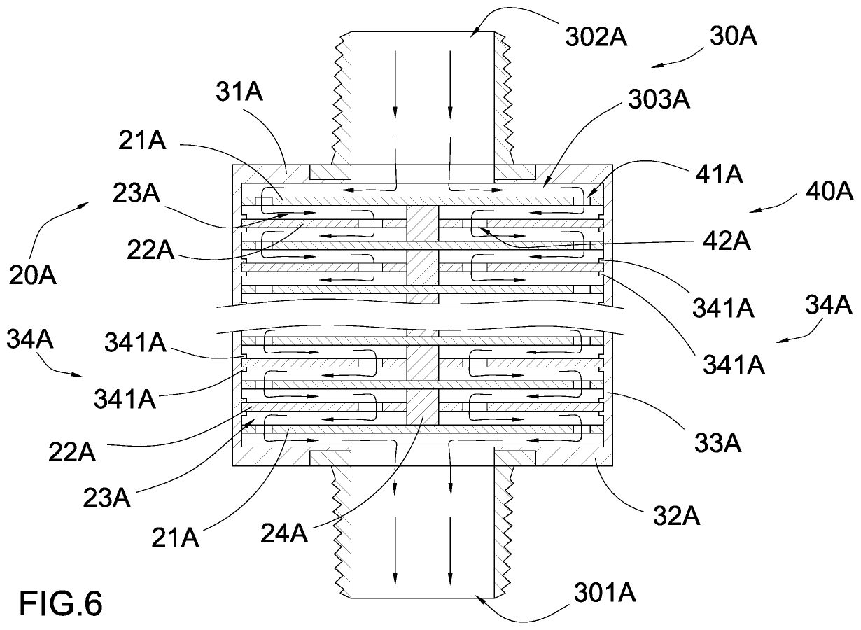

FIG. 6 further illustrates an alternative mode of the disc supporting structure, wherein the supporting shaft 24A is coaxially extended at the central portions of the first splitting discs 21A and the central portions of the second splitting discs 22A in order to couple the first splitting discs 21A which are alternating with the second splitting discs 22A within the splitting compartment 303A of the splitting housing 30A. Accordingly, the central through slots 222A are coaxially and spacedly formed around the supporting shaft 24A.

In addition, the splitting housing 30A further comprises a plurality of disc holders 34A spacedly provided at the surrounding wall 33A of the splitting housing 30A to couple with the peripheral edges of the second splitting discs 22A so as to spacedly support the second splitting discs 22A within the splitting compartment 303A. Accordingly, each of the disc holders 34A comprises two holding rings 341A spacedly, radially, and inwardly protruded from the surrounding wall 33A of the splitting housing 30A. Preferably, the holding rings 341A are integrally protruded from the surrounding wall 33A of the splitting housing 30A. The distance between the two holding rings 341A in pair matches with a thickness of the second splitting disc 22A, such that the peripheral edge of the second splitting disc 22A is held between the holding rings 341A for being supported in the splitting compartment 303A.

It is worth mentioning that the splitting housing 30A is constructed to have a first half casing 351A and a second half casing 352A identical to the first half casing 351A, wherein the first and second half casings 351A, 352A are coupled edge to edge to form the splitting housing 30A. In other words, the first wall 31A, the second wall 32A, and the surrounding wall 33A are divided into two halves for the first and second half casings 351A, 352A. Furthermore, no disc spacer is required in this alternative mode since the first and second splitting discs 21A, 22A are spacedly supported by the supporting shaft 24A, and the second splitting disc 22A are held by the disc holders 34A.

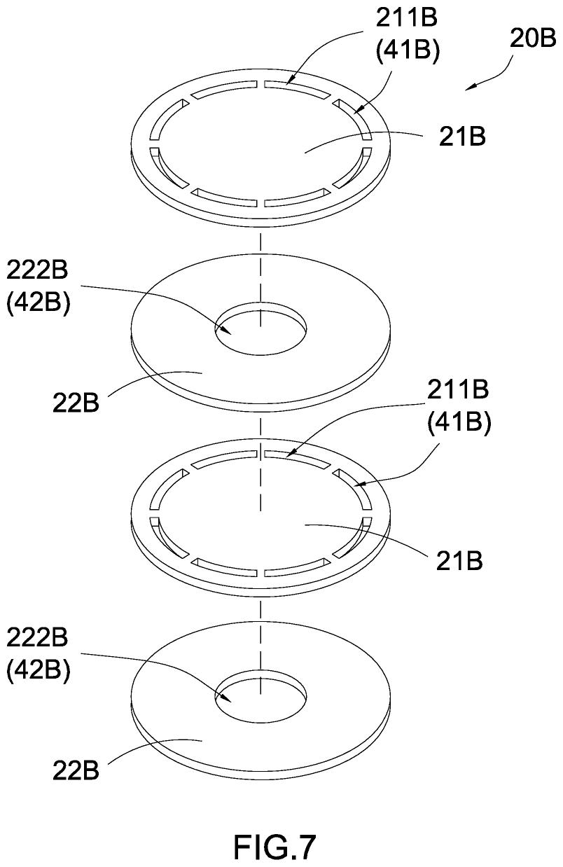

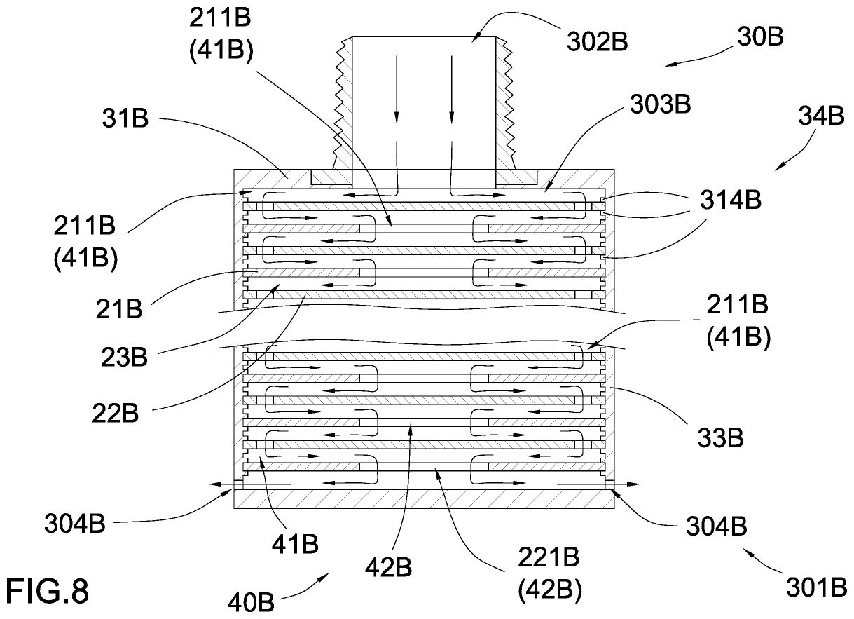

FIGS. 7 and 8 illustrates a second alternative mode of the bubble splitter 20B. Accordingly, the splitter housing 30B has an outlet 301B, an inlet 302B connected to the bubble generator 10, and a splitting compartment 303B defined between the outlet 301B and the inlet 302B. Accordingly, the splitting housing 30B has a cylindrical shape to define a first wall 31B, a second wall 32B and a surrounding wall 33B extended between the first and second walls 31B, 32B to define the splitting compartment 303B within the surrounding wall 33B. The outlet 301B is formed at the second wall 32B and the inlet 302B is formed at the first wall 31B.

The first splitting discs 21B are alternating with the second splitting discs 22B within the splitting compartment 303B of the splitting housing 30B, and the first and second splitting discs 21B, 22B are spacedly supported within the splitting compartment 303B. A plurality of splitting channels 23B are formed between the first and second splitting discs 21B, 22B. Accordingly, the diameter of the first splitting disc 21B is the same as the diameter of the second splitting disc 22B.

The bubble splitting configuration 40B is provided in the splitting compartment 303B to detour the gas bubbles in liquid from the inlet 302B to the outlet 301B through the splitting compartment 303B so as to complete the bubble splitting process via the peripheral passages 41B and the central passages 42B.

The configuration of the first splitting disc 21B is the same as that of the first splitting disc 21A, wherein the peripheral passages 41B are formed at peripheral portions of the first splitting discs 21B respectively. In particular, each of the first splitting discs 21B has a plurality of peripheral through slots 211B spacedly and coaxially formed at the peripheral portion of the first splitting disc 21B to form the peripheral passages 41B thereat. Accordingly, each of the peripheral through slots 211B has an arc shape formed at the peripheral portion of the first splitting disc 21B.

The configuration of the second splitting disc 22B is the same as that of the second splitting disc 22, wherein the central passages 42B are formed at the center portions of the second splitting discs 22B respectively. In particular, each of the second splitting discs 22B has a central through slot 221B formed at a center thereof to define the central passage 42B thereat.

Therefore, the gas bubbles are split in half by turning 180° at the peripheral passages 41B via the peripheral through slots 211B and turning 180° at the central passages 42B via the central through slots 221B in sequence.

FIG. 8 further illustrates another alternative mode of the disc supporting structure, wherein the first and second splitting discs 21B, 22B are spacedly supported within the splitting compartment 303B in a shaft-less manner. Accordingly, the splitting housing 30B further comprises a plurality of disc holders 34B spacedly provided at the surrounding wall 33B of the splitting housing 30B to couple with the peripheral edges of the first and second splitting discs 21B, 22B so as to spacedly support the first and second splitting discs 21B, 22B within the splitting compartment 303B. Accordingly, each of the disc holders 34B comprises two holding rings 341B spacedly, radially, and inwardly protruded from the surrounding wall 33B of the splitting housing 30B. Preferably, the holding rings 341B are integrally protruded from the surrounding wall 33B of the splitting housing 30B. The distance between the two holding rings 341B in pair matches with a thickness of each of the first and second splitting discs 21B, 22B, such that the peripheral edge of each of the first and second splitting discs 21B, 22B is held between the holding rings 341B for being supported in the splitting compartment 303B. In other words, in this alternative mode, the splitting housing 30B does not require any supporting shaft or disc spacer to spacedly support the first and second splitting discs 21B, 22B in the splitting housing 30B.

FIG. 8 further illustrates another alternative mode of the splitting housing 30B, wherein the inlet 302B is not aligned with the outlet 301B. Accordingly, the outlet 301B of the splitting housing 30B has a plurality of discharging passages 304B spacedly formed at the surrounding wall 33B of the splitting housing 33B. In other words, the inlet 302B is formed at a center of the first wall 31B, wherein the second wall 32B is a solid wall. The discharging passages 304B are spacedly formed at the circumference of the surrounding wall 33B at a position close to the second wall 32B to communicate with the splitting compartment 303B.

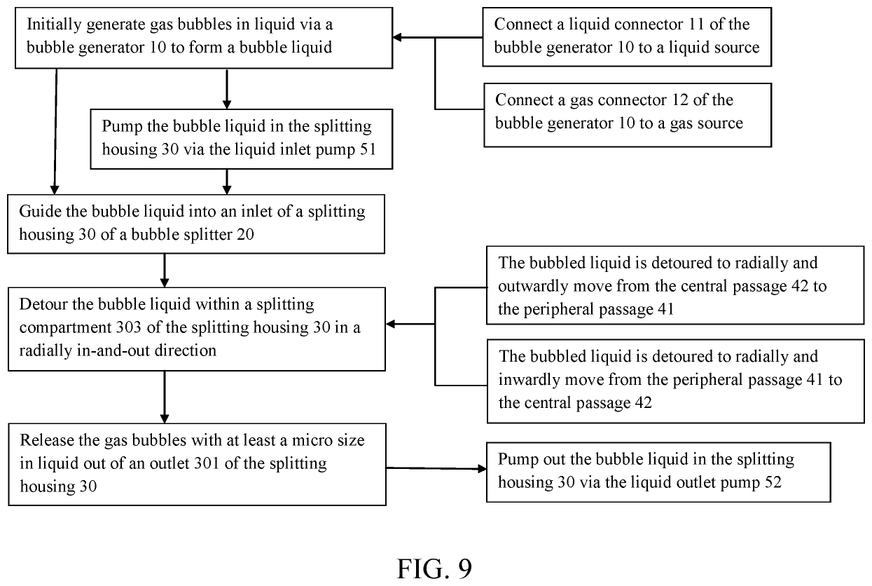

FIG. 9 illustrates a method of generating gas bubbles, each having at least a micro size, in liquid, comprising the following steps.

(1) Initially generate the gas bubbles in liquid via the bubble generator 10 to form the bubble liquid. Accordingly, the gas bubbles in liquid is initially generated by selecting the gas as at least one of air, oxygen gas, ozone gas, hydrogen gas, carbon dioxide gas, and/or nitrogen gas, and selecting the liquid as one of purified water, drinking water, tape water, gaseous fuel, and/or diesel fuel. In other words, the liquid connector 11 of the bubble generator 10 is connected to the liquid source to select the liquid, and the gas connector 12 of the bubble generator 10 is connected to the gas source to select the gas.

(2) Guide the bubble liquid into the inlet 302 of the splitting housing 30 of the bubble splitter 20.

(3) Detour the bubble liquid within the splitting compartment 303 of the splitting housing 30 in a radially in-and-out direction via the peripheral passages 41 and the central passages 42 alternating with the central passages 42 within the splitting compartment 303. Accordingly, the bubbled liquid is detoured to radially and outwardly move from the central passage 42 to the peripheral passage 41, and the bubbled liquid is detoured to radially and inwardly move from the peripheral passage 41 to the central passage 42 so as to split the gas bubbles in the bubbled liquid in at least a micro size.

(4) Release the gas bubbles with at least a micro size in liquid out of the outlet 301 of the splitting housing 30.

The method of the present invention further comprises, before the step (1), a step of operatively connecting the liquid inlet pump 51 to the bubble generator for pumping the liquid thereto. It is worth mentioning the liquid inlet pump 51 can be incorporated to pump the liquid into the inlet 302 of the splitting housing 30 before the gas bubbles are formed in the liquid or after the gas bubbles are formed in the liquid as the bubbled liquid. At the step (4), the method further comprises a step of operatively connecting the liquid outlet pump 52 to the bubble splitter 20 for pumping the gas bubbles with at least a micro size in liquid out of the outlet 301 of the splitting housing 30.

According to the preferred embodiment, the bubble generation system of the present invention can be formed as a portable water treatment device, wherein the bubble splitter 20 can be simply coupled at the shower head, faucets in bedroom or kitchen, and/or inlet of the laundry. It is worth mentioning that the preferred embodiment and its alternative modes are interchangeable. For example, the first splitting discs 21, 21A, 21B, and the second splitting discs 22, 22A, 22B are interchangeable that the first splitting discs 21 can be incorporated with the second splitting discs 22B. The disc supporting structure and its alternatives can be used for the first splitting discs 21, 21A, 21B, and the second splitting discs 22, 22A, 22B.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A bubble generation system, comprising:
a bubble generator adapted for generating gas bubbles in liquid to form a bubbled liquid; and
a bubble splitter communicatively connected to said bubble generator for splitting the gas bubbles in the bubbled liquid in at least a micro size, wherein said bubble splitter comprises:
a tubular splitting housing having an outlet, an inlet connected to said bubble generator, and a splitting compartment defined between said outlet and said inlet; and
a bubble splitting configuration provided in said splitting compartment, which comprises:
a plurality of peripheral passages defined at a peripheral portion of said splitting housing; and
a plurality of central passages defined at a center portion of said splitting housing, wherein said peripheral passages are alternating with said central passages within said splitting compartment for detouring the bubbled liquid from said inlet to said outlet in such a manner that the bubbled liquid is detoured to radially and outwardly move from said central passage to said peripheral passage and is detoured to radially and inwardly move from said peripheral passage to said central passage so as to split the gas bubbles in the bubbled liquid in at least a micro size.

2. The bubble generation system, as recited in claim 1, wherein said bubble splitter comprises a plurality of first splitting discs and a plurality of second splitting discs alternating with said first splitting discs and spacedly supported within said splitting compartment, wherein said peripheral passages are formed at peripheral portions of said first splitting discs respectively and said central passages are formed at center portions of said second splitting discs respectively.

3. The bubble generation system, as recited in claim 4, wherein a plurality of splitting channels are formed between said first and second splitting discs to communicate between said peripheral passages and said central passages.

4. The bubble generation system, as recited in claim 3, wherein a diameter of each of said first splitting discs is smaller than a diameter of said splitting housing, such that each of said peripheral passages is formed between a peripheral edge of said first splitting disc and a surrounding wall of said splitting housing.

5. The bubble generation system, as recited in claim 4, wherein each of said second splitting discs has a central through slot defining said central passage thereat.

6. The bubble generation system, as recited in claim 5, wherein said bubble splitter further comprises a supporting shaft coaxially extended at central portions of said first splitting discs to spacedly support said first splitting discs within said splitting compartment.

7. The bubble generation system, as recited in claim 6, wherein said supporting shaft is coaxially extended through said central through slots of said second splitting discs that a diameter of said supporting shaft is smaller than a diameter of said central through slot.

8. The bubble generation system, as recited in claim 7, wherein said splitting housing further comprises a plurality of disc holders spacedly provided at said surrounding wall of said splitting housing to couple with peripheral edges of said second splitting discs so as to spacedly support said second splitting discs within said splitting compartment.

9. The bubble generation system, as recited in claim 7, wherein peripheral edges of said second splitting discs are integrally extended to said surrounding wall of said splitting housing so as to spacedly support said second splitting discs within said splitting compartment.

10. The bubble generation system, as recited in claim 3, wherein each of said first splitting discs has a plurality of peripheral through slots spacedly and coaxially formed at a peripheral portion of said first splitting disc to form said peripheral passages thereat.

11. The bubble generation system, as recited in claim 3, wherein each of said second splitting discs has a plurality of central through slots spacedly and coaxially formed at a center portion of said first splitting disc to form said central passages thereat.

12. The bubble generation system, as recited in claim 2, wherein a diameter of each of said first splitting discs is smaller than a diameter of each of said second splitting discs.

13. The bubble generation system, as recited in claim 2, wherein a diameter of each of said first splitting discs is equal to a diameter of each of said second splitting discs.

14. The bubble generation system, as recited in claim 1, wherein said inlet of said splitting housing is coaxially aligned with said outlet thereof.

15. The bubble generation system, as recited in claim 1, wherein said outlet of said splitting housing has a plurality of discharging passages spacedly formed at a surrounding wall of said splitting housing.

16. The bubble generation system, as recited in claim 1, wherein said bubble generator comprises a liquid connector adapted for connecting to a liquid source, and a gas connector adapted for connecting to a gas source.

17. The bubble generation system, as recited in claim 16, wherein said liquid connector is a water connector and said gas connector is an oxygen gas connector, such that said liquid connector is arranged for generating oxygen bubble in water.

18. The bubble generation system, as recited in claim 16, wherein said liquid connector is a water connector and said gas connector is an ozone gas connector, such that said liquid connector is arranged for generating ozone bubble in water.

19. The bubble generation system, as recited in claim 16, wherein said liquid connector is a water connector and said gas connector is an air connector, such that said liquid connector is arranged for generating air bubble in water.

20. The bubble generation system, as recited in claim 16, wherein said liquid connector is a diesel fuel connector and said gas connector is an oxygen gas connector, such that said liquid connector is arranged for generating oxygen bubble in diesel fuel.

21. The bubble generation system, as recited in claim 1, further comprising a liquid inlet pump operatively connecting to said bubble generator for pumping the liquid thereto.

22. The bubble generation system, as recited in claim 1, further comprising a liquid outlet pump operatively connecting to said bubble splitter for pumping the gas bubbles with at least a micro size in liquid out of said outlet of said splitting housing.

23. A method of generating gas bubbles, each having at least a micro size, in liquid, comprising the steps of:
(a) initially generating gas bubbles in liquid via a bubble generator to form a bubble liquid;
(b) guiding said bubble liquid into an inlet of a splitting housing of a bubble splitter;
(c) detouring said bubble liquid within a splitting compartment of said splitting housing in a radially in-and-out direction via a plurality of peripheral passages and a plurality of central passages alternating with said central passages within said splitting compartment that:
said bubbled liquid is detoured to radially and outwardly move from said central passage to said peripheral passage, and
said bubbled liquid is detoured to radially and inwardly move from said peripheral passage to said central passage so as to split said gas bubbles in the bubbled liquid in at least a micro size; and
(d) releasing said gas bubbles with at least a micro size in liquid out of an outlet of said splitting housing.

24. The method as recited in claim 23 wherein, in the step (c), said peripheral passages and said central passages are formed by:
spacedly supporting a plurality of first splitting discs and a plurality of second splitting discs within said splitting compartment at a position that said first splitting discs are alternating with said second splitting discs;
forming said peripheral passages at peripheral portions of said first splitting discs respectively;
forming said central passages at center portions of said second splitting discs respectively and
forming a plurality of splitting channels between said first and second splitting discs to communicate between said peripheral passages and said central passages.

25. The method as recited in claim 23 wherein, in the step (a), further comprises the steps of:
(a.1) connecting a liquid connector of said bubble generator to a liquid source; and
(a.2) connecting a gas connector of said bubble generator to a gas source.

26. The method, as recited in claim 25, wherein said liquid connector is a water connector and said gas connector is an oxygen connector, such that said liquid connector is arranged for generating oxygen bubble in water.

27. The method, as recited in claim 25, wherein said liquid connector is a water connector and said gas connector is a nitrogen connector, such that said liquid connector is arranged for generating nitrogen bubble in water.

28. The method, as recited in claim 25, wherein said liquid connector is a water connector and said gas connector is an air connector, such that said liquid connector is arranged for generating air bubble in water.

29. The method, as recited in claim 25, wherein said liquid connector is a diesel fuel connector and said gas connector is an oxygen connector, such that said liquid connector is arranged for generating oxygen bubble in diesel fuel.

30. The method, as recited in claim 23, before the step (a), further comprising a step of operatively connecting a liquid inlet pump to said bubble generator for pumping the liquid thereto.

31. The method as recited in claim 23 wherein, in the step (d), further comprises a step of operatively connecting a liquid outlet pump to said bubble splitter for pumping the gas bubbles with at least a micro size in liquid out of said outlet of said splitting housing.

32. A bubble splitter for splitting gas bubbles in a bubbled liquid in at least a micro size, comprising:
a tubular splitting housing having an outlet, an inlet connected to said bubble generator, and a splitting compartment defined between said outlet and said inlet;
a plurality of first splitting discs spacedly supported within said splitting compartment, wherein a plurality of peripheral passages are formed at peripheral portions of said first splitting discs respectively; and
a plurality of second splitting discs spacedly supported within said splitting compartment and alternating with said first splitting discs, wherein a plurality of central passages are formed at center portions of said second splitting discs respectively, wherein said splitting housing is arranged for detouring the bubbled liquid from said inlet to said outlet in such a manner that the bubbled liquid is detoured to radially and outwardly move from said central passage to said peripheral passage and is detoured to radially and inwardly move from said peripheral passage to said central passage so as to split the gas bubbles in the bubbled liquid in at least a micro size.

33. The bubble splitter, as recited in claim 32, wherein a plurality of splitting channels are formed between said first and second splitting discs to communicate between said peripheral passages and said central passages.

34. The bubble splitter, as recited in claim 33, wherein a diameter of each of said first splitting discs is smaller than a diameter of said splitting housing, such that each of said peripheral passages is formed between a peripheral edge of said first splitting disc and a surrounding wall of said splitting housing.

35. The bubble splitter, as recited in claim 33, wherein each of said first splitting discs has a plurality of peripheral through slots spacedly and coaxially formed at a peripheral portion of said first splitting disc to form said peripheral passages thereat.

36. The bubble splitter, as recited in claim 33, wherein each of said second splitting discs has a central through slot defining said central passage thereat.

37. The bubble splitter, as recited in claim 33, wherein each of said second splitting discs has a plurality of central through slots spacedly and coaxially formed at a center portion of said first splitting disc to form said central passages thereat.

38. The bubble splitter, as recited in claim 33, wherein said bubble splitter further comprises a supporting shaft coaxially extended at central portions of said first splitting discs to spacedly support said first splitting discs within said splitting compartment.

39. The bubble splitter, as recited in claim 33, wherein said splitting housing further comprises a plurality of disc holders spacedly provided at a surrounding wall of said splitting housing to couple with peripheral edges of said second splitting discs so as to spacedly support said second splitting discs within said splitting compartment.

40. The bubble splitter, as recited in claim 33, wherein a diameter of each of said first splitting discs is smaller than a diameter of each of said second splitting discs.

41. The bubble splitter, as recited in claim 33, wherein a diameter of each of said first splitting discs is equal to a diameter of each of said second splitting discs.
